(19) United States
(12) Patent Application Publication
(10) Pub. No.: US 2026/0120411 A1
(43) Pub. Date: Apr. 30, 2026

(54) APPARATUS AND METHOD FOR IMPROVING VISUALIZATION QUALITY OF XR DEVICE

(71) Applicant: Korea Electronics Technology Institute, Seongnam-si (KR)

(72) Inventors: Yoon Mo YANG, Goyang-si (KR); Kwang Soon CHOI, Goyang-si (KR); Ji Woon YEOM, Hwaseong-si (KR); Ye Seul SON, Seoul (KR)

(73) Assignee: Korea Electronics Technology Institute, Seongnam-si (KR)

(21) Appl. No.: 19/162,109

(22) PCT Filed: Sep. 23, 2024
(86) PCT No.: PCT/KR2024/014248

§ 371 Date: Sep. 4, 2025

(30) Foreign Application Priority Data
Nov. 29, 2023 (KR) 10-2023-0169548

(51) Int. Cl. G06T 19/00; G06N 3/045; G06N 3/08; G06T 5/80

(52) U.S. Cl. CPC G06T 19/00; G06N 3/045; G06N 3/08; G06T 5/80

(57) ABSTRACT

An apparatus and a method for improving the visualization quality of an XR device are provided. In the method for improving visualization quality according to an embodiment of the present invention, a rendered image is input into a first neural network to generate a modified image, the modified image is transferred through an optical system, and the transferred image is input into a second neural network to generate a modified image. Accordingly, when the rendered image is provided to a user of the XR device, image distortion caused by the optical system is minimized and, as a result, a high-quality image is provided, so that strangeness felt by the user in a state where real content and virtual content are mixed can be minimized.

### TECHNICAL FIELD

The disclosure relates to improvement of image quality, and more particularly, to a method for providing content of high quality to a user by minimizing a distortion caused by a lens of an optical system when rendered content is provided to the user by projecting through the optical system in an extended reality (XR) device.

### BACKGROUND ART

In order to minimize an image distortion occurring when a content image passes through a lens of an optical system of a related-art XR device, the XR device may use a method of compensating for the distortion occurring when the image passes through the lens by adding a distortion of the opposite property to offset the distortion to the content and projecting through the optical system.

However, since even the same kind of XR devices have different distortion aberrations, there is a limit to providing optimal image quality to users in the above-described method.

### DISCLOSURE

### Technical Problem

The disclosure has been developed to solve the above-described problems, and an object of the disclosure is to provide an apparatus and a method for improving visualization quality of an XR device, which are capable of providing an image of high quality by minimizing an image distortion caused by an optical system when a rendered image is provided to a user in the XR device.

### Technical Solution

According to an embodiment of the disclosure to achieve the above-described object, a visualization quality improvement method may include: a first generation step of generating a modified image by inputting a rendered image to a first neural network; a step of passing the modified image through an optical system and transferring; and a second generation step of generating a modified image by inputting the transferred image to a second neural network.

The image passing through the optical system at the step of transferring may be modified to an image that is distorted by a lens of the optical system.

The distorted image may be an image to which a barrel distortion is added by the lens of the optical system.

The first neural network and the second neural network may be simultaneously trained by end-to-end learning.

The first neural network and the second neural network may be trained to reduce a loss between the rendered image inputted to the first neural network and the modified image outputted from the second neural network.

The loss function may be a loss function that is generated by a peak signal-to-noise ratio (PSNR), a structural similarity index measure (SSIM), or weighted-summing a PSNR and SSIM.

The rendered image may be a chess board image or a structured light pattern image.

The visualization quality improvement according to the disclosure may include displaying the modified image generated in the second neural network.

The rendered image may be an image that is to be displayed through an XR device.

According to another aspect of the disclosure, there is provided a visualization quality improvement apparatus including: a first neural network configured to receive a rendered image and to generate a modified image; and a second neural network configured to receive the image that is transferred through an optical system after being modified in the first neural network, and to generate a modified image.

According to still another aspect of the disclosure, there is provided an image display method including: a step of rendering an image; a first generation step of generating a modified image by inputting the rendered image to a first neural network; a step of passing the modified image through an optical system and transferring; a second generation step of generating a modified image by inputting the transferred image to a second neural network; and a step of displaying the modified image generated in the second generation step.

According to yet another aspect of the disclosure, there is provided an image display apparatus including: a rendering unit configured to render an image; a first neural network configured to receive the rendered image and to generate a modified image; a second neural network configured to receive the image that is transferred through an optical system after being modified in the first neural network, and to generate a modified image; and a display unit configured to display the modified image generated by the second neural network.

### Advantageous Effects

As described above, according to embodiments of the disclosure, when a rendered image is provided to a user of the XR device, an image distortion caused by an optical system may be minimized and an image of high quality may be provided, so that strangeness felt by the user in a state in which real content and virtual content are mixed may be minimized.

### DESCRIPTION OF DRAWINGS

FIG. 1 is a view illustrating a barrel distortion.

FIG. 2 is a view illustrating a pincushion distortion.

FIG. 3 is a view illustrating an XR device visualization quality improvement apparatus according to an embodiment.

FIG. 4 is a view illustrating a configuration of an XR device according to another embodiment.

### BEST MODE

Hereinafter, the disclosure will be described in more detail with reference to the drawings.

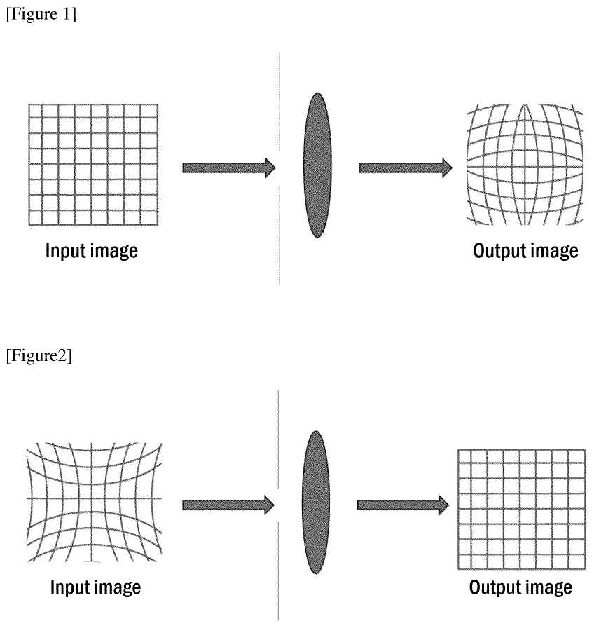

An XR device may have a problem that an image is distorted in the process of rendering content and projecting a content screen through a lens of an optical system to output the same through an XR screen. FIG. 1 shows a distortion of an XR device.

As shown in the drawing, when an input image passes through a lens of an optical system of an XR device, a barrel distortion may occur in an output image. To this end, some pixels may be mapped onto one pixel or one pixel may be mapped at various locations due to the change in the grid of the output image, which degrades image quality of content.

To solve this problem, providing content that is rendered through a process as shown in FIG. 2 to a user may be conceived. This is to make an artificial distortion before projecting the rendered content through the optical system and to correct the distortion through a lens.

Specifically, a distorted input image may be generated by applying a pincushion distortion to the rendered image, and then, by passing the input image through the lens of the optical system of the XR device, an output image may be provided to a user.

However, since it is common that even the same kind of XR devices have different distortion aberrations of the barrel distortion depending on mass-produced lenses, it is necessary to find an optimal distortion aberration after XR devices are produced.

Embodiments of the disclosure propose an apparatus and a method for improving visualization quality of an XR device. The disclosure relates to a technology for providing a user with an image of high quality without a distortion by using a method of correcting a distortion by comparing a rendered image and quality of an image provided to the user, rather than using a method of mathematically correcting a distortion caused by a lens constituting an optical system of an XR device.

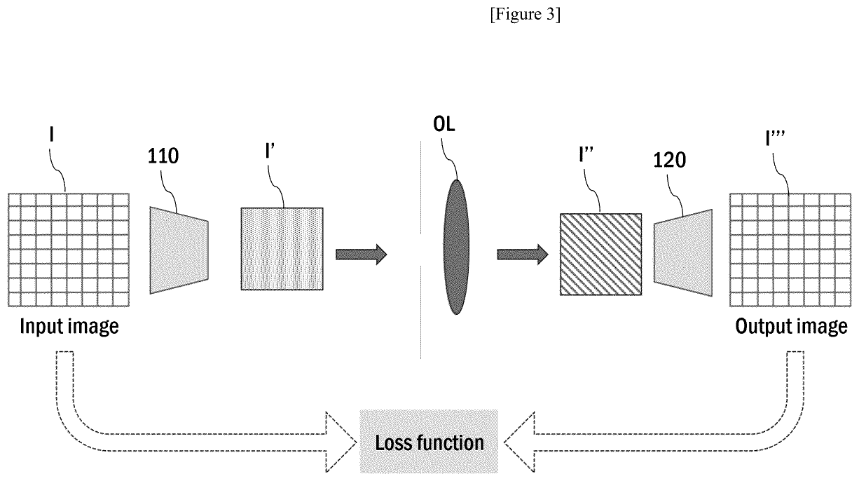

FIG. 3 is a view illustrating a configuration of an XR device visualization quality improvement apparatus according to an embodiment of the disclosure. The XR device visualization quality improvement apparatus according to an embodiment of the disclosure may include a neural network-1 110 and a neural network-2 120 as shown in the drawing.

The neural network-1 110 refers to a neural network that receives a rendered image I to provide through an XR device, and generates a modified image I′, or a processor for executing the same.

The image I′ modified by the neural network-1 110 is modified to an image I″ to which a barrel distortion is added by a lens OL of the optical system in the process of passing through the lens OL of the optical system of the XR device and being transferred.

The neural network-2 120 refers to a neural network that receives the distorted image I″ transferred through the lens OL of the optical system and generates a modified image I′″, or a processor for executing the same. The modified image I′″ outputted from the neural network-2 120 is an image that is displayed for the user, that is, viewed by the user.

The neural network-1 110 and the neural network-2 120 may be simultaneously trained by end-to-end learning. Specifically, the neural network-1 110 and the neural network-2 120 may be trained to reduce a loss (difference) between the modified image I′″, which is the output image outputted from the neural network-2 120, and the rendered image I which is the input image to the neural network-1 110.

A loss function may use a peak signal-to-noise ratio (PSNR) or a structural similarity index measure (SSIM), and a loss function generated by weighted-summing a PSNR and a SSIM may be used.

As an input image to the neural network-1 110, normal content may be used or a pattern image such as a chess board image or a structured light pattern image may be used.

An image display means may be provided between the neural network-1 110 and the optical system, and an image sensor may be provided between the optical system and the neural network-2 120. Illustration of the corresponding components may be omitted from FIG. 3 for the sake of strengthening of understanding of the concept of the present invention.

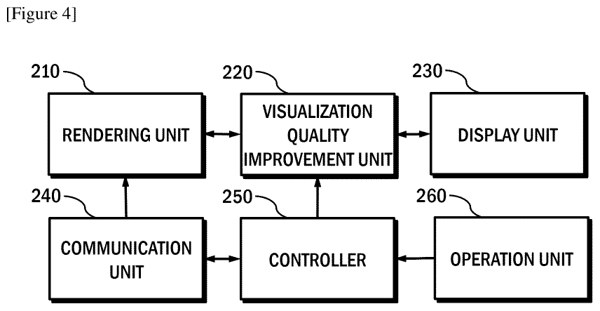

FIG. 4 is a view illustrating a configuration of an XR device according to another embodiment of the disclosure. The XR device according to an embodiment of the disclosure may include a rendering unit 210, a visualization quality improvement unit 220, a display unit 230, a communication unit 240, a controller 250, and an operation unit 260 as shown in the drawing.

The rendering unit 210 may render an XR image to provide to a user. The visualization quality improvement unit 220 may be a processor and a memory for executing the neural networks 110, 120 constituting the visualization quality improvement apparatus proposed through FIG. 3 described above.

The display unit 230 may be configured to display an image that is obtained by rendering by the rendering unit 210 and then removing a barrel distortion by the visualization quality improvement unit 220, and to provide the image to a user.

The communication unit 240 may be a means for communicating with an external device, an external network, and may receive an XR image or may receive an external control command. The controller 250 may control overall operations of the XR device according to an external command inputted through the communication unit 240 or a user command inputted through the operation unit 260.

Up to now, the apparatus and the method for improving visualization quality of an XR device and an XR device applying the same have been described in detail with reference to preferred embodiments.

In the above embodiments, when a rendered image is provided to a user of the XR device, an image distortion caused by an optical system may be minimized and an image of high quality may be provided, so that strangeness felt by the user in a state in which real content and virtual content are mixed may be minimized.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

1. A visualization quality improvement method comprising:
a first generation step of generating a modified image by inputting a rendered image to a first neural network;
a step of passing the modified image through an optical system and transferring; and
a second generation step of generating a modified image by inputting the transferred image to a second neural network,
wherein the image passing through the optical system at the step of passing is an image to which a barrel distortion is added by the lens of the optical system.

2. (canceled)

3. (canceled)

4. The visualization quality improvement method of claim 1, wherein the first neural network and the second neural network are simultaneously trained by end-to-end learning.

5. The visualization quality improvement method of claim 4, wherein the first neural network and the second neural network are trained to reduce a loss between the rendered image inputted to the first neural network and the modified image outputted from the second neural network.

6. The visualization quality improvement method of claim 5, wherein the loss function is a loss function that is generated by a peak signal-to-noise ratio (PSNR), a structural similarity index measure (SSIM), or weighted-summing a PSNR and SSIM.

7. The visualization quality improvement method of claim 1, wherein the rendered image is a chess board image or a structured light pattern image.

8. The visualization quality improvement method of claim 1, comprising displaying the modified image generated in the second neural network.

9. The visualization quality improvement method of claim 1, wherein the rendered image is an image that is to be displayed through an XR device.

10. (Canceled)

11. An image display method comprising:
a step of rendering an image;
a first generation step of generating a modified image by inputting the rendered image to a first neural network;
a step of passing the modified image through an optical system and transferring;
a second generation step of generating a modified image by inputting the transferred image to a second neural network; and
-a step of displaying the modified image generated in the second generation step.
wherein the image passing through the optical system at the step of passing is an image to which a barrel distortion is added by the lens of the optical system.

12. An image display apparatus comprising:
a rendering unit configured to render an image;
a first neural network configured to receive the rendered image and to generate a modified image;
a second neural network configured to receive the image that is transferred through an optical system after being modified in the first neural network, and to generate a modified image; and
a display unit configured to display the modified image generated by the second neural network.
wherein the image passing through the optical system is an image to which a barrel distortion is added by the lens of the optical system.
